(19) United States
(12) Patent Application Publication
(10) Pub. No.: US 2004/0224043 A1
(43) Pub. Date: Nov. 11, 2004

(54) Simultaneous main-sub component molding method for resin components of vehicular lamp, and molding apparatus therefor

(75) Inventors: Mamoru Kosuge, Shizuoka (JP); Akinori Yamamoto, Shizuoka (JP); Kenichiro Yabusaki, Shizuoka (JP)

Correspondence Address: SUGHRUE MION, PLLC, 2100 Pennsylvania Avenue, NW, Washington, DC, 20037-3213, US

(73) Assignee: KOITO MANUFACTURING CO., LTD

(21) Appl. No.: 10/772,428

(22) Filed: Feb. 6, 2004

(30) Foreign Application Priority Data
Feb. 6, 2003 (JP) P.2003-029378

(51) Int. Cl. B29C 45/22; B29C 45/16

(52) U.S. Cl. 425/120; 425/129.1; 425/572

(57) ABSTRACT

To provide a method and an apparatus that can execute simultaneous injection molding of a plurality of different resin components using a mold construction that makes possible simultaneous main-sub component molding, without having to make the mold and device larger. A simultaneous main-sub component molding method utilizes a mold device having a first cavity C1 for molding a first resin component and a second cavity C2 for molding a second resin component. The mold cavities C1 and C2 are provided in a pair of opposed mold halves 100, 200 which close for the molding operation and open to remove the molded parts. In this mold device, injection molding of a plurality of different types of resin components 20, 23 is simultaneous. The first resin component is configured from a large resin component that is substantially circular, U-shaped, or L-shaped. The second resin component is configured from a small resin component that can be positioned inside an open portion of the first resin component. The mold halves 100, 200, which have the smaller cavity C2 inside the larger cavity C1, are substantially the same size as a mold which has only first cavity C1, and which independently molds the first resin component. As a result, the mold is smaller than a conventional mold 4 (5) for simultaneous main-sub component molding, in which the second cavities C2 are positioned outside the first cavities C1.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The present invention relates to a simultaneous main-sub component molding method for resin components, and to an apparatus therefor, in which a plurality of different resin components of a vehicular lamp are injection molded simultaneously, utilizing a mold in which a plurality of adjacently provided cavities extend between opposed mold halves.

FIGS. 13 and 14 show a mold device which is a main portion of a molding apparatus that executes simultaneous injection molding of an extension reflector and an inner lens that are resin components of a headlamp. The mold used in the molding apparatus has a fixed mold half 4 that is on a side supplied with molten resin from an injector nozzle 2, and a movable mold half 5 which faces the fixed mold half 4 and which moves away from and toward the fixed mold half 4 to open and close the mold. Cavities 6, 7 that correspond to the extension reflector and the inner lens that are to be formed are provided near each other between the opposed mold halves 4, 5. Molten resin supplied from the injector nozzle 2 is injected into the respective cavities 6, 7 via a sprue portion 8 and hot runners 9, 10.

As shown in FIG. 14, at opposing faces of the mold halves 4, 5, the cavities 6, 7 are disposed along respective symmetric lines. The sprue portion 8 is provided at a substantially central portion of the fixed mold half 4, and the runners 9, 10 spread in a cross-shape perpendicularly to the sprue portion 8 to reach the respective cavities 6, 7.

The described mold apparatus utilizes a simultaneous main-sub component mold construction which enables simultaneous molding of both the extension reflector and the inner lens. Accordingly, there is no need to switch molds in order to mold the respective parts; one mold is sufficient; the molding apparatus has a simpler construction; and component and headlamp costs are lower.

However, with the simultaneous main-sub component molding mold construction shown in FIG. 14, because the cavities for molding the extension reflector and the inner lens cannot interfere with each other, the molds become unavoidably large as compared to the case of a mold A that independently molds just the extension reflector (see the dashed line in FIG. 14). The larger mold increases mold manufacturing costs, the amount of energy necessary to drive the mold, the overall size of the molding apparatus, and the like. As a result, it is not possible to exploit effectively the cost reduction benefit that results from simpler construction of the molding apparatus.

In view of the foregoing, it would be desirable to have the inner lens and extension reflector sized so that the inner lens can fit entirely inside the extension reflector. Then, it would be possible to provide a mold that is substantially the same size as the mold A that independently molds the extension reflector, by placing the cavity 7 for molding the inner lens inside the cavity 6 for molding the extension reflector.

### SUMMARY OF THE INVENTION

In view of the foregoing, it is one object of the invention to provide a molding method and apparatus for simultaneous injection molding of a plurality of different resin components, without increasing the size of the molds or the molding apparatus.

In order to accomplish the above and other objects, according to a simultaneous main-sub component method and apparatus for molding resin components of a vehicular lamp, simultaneous injection molding of a plurality of resin components of different types is accomplished with a mold having a first cavity for molding a first resin component and a second cavity for molding a second resin component. The first and second cavities extend between a pair of opposed mold halves, at least one of which moves to enable opening and closing of the mold. According to one embodiment, the first, larger resin component has a frame-like shape such as a circular shape, a U-shape, or an L-shape, and the second resin component, which is smaller, is positioned inside the first resin component without interfering with the first resin component.

The mold configured as described is substantially the same size as a mold which is provided only with the first cavity and which independently molds only the first resin component. As a result, the mold is smaller than conventional molds for simultaneous main-sub component molding.

According to another aspect of the invention, the first and second cavities are connected by a resin passage that is provided in the mold halves, and molten resin is injected into one of the first cavity or the second cavity via a resin supply passage provided in the mold halves. With this configuration, molten resin is injected from the resin supply passage to one of the cavities, and then is injected from this cavity to the other cavity via the resin passage.

According to a further aspect of the invention, the molten resin is injected into the first and second cavities via respective resin supply passages provided in the mold halves. In this way, molten resin is injected from respective injectors into the first and second cavities via the respective resin passages.

According to yet another aspect of the invention, molten resin is injected into the first and second cavities via a resin supply passage which has a branch at a mid-point, which extends to the respective cavities, and which is provided in the mold halves. In this way, molten resin supplied in the resin supply passage is injected simultaneously into the first and second cavities via the branch supply passage.

According to a still further aspect of the invention, the first resin component is an extension reflector for a headlamp, and the second resin component is another headlamp component that is smaller than an open portion of the extension reflector.

A headlamp extension reflector is relatively large, and generally is circular with an open portion substantially corresponding in size to a reflector disposed to the rear of the reflector. As a result, the extension reflector easily serves as the main component for the simultaneous main-sub component molding. Further, it is favorable to have another, smaller headlamp component as the sub-component for the main-sub component molding, to fit inside the open portion of the extension reflector. Headlamps that integrate indicator lamps such as a clearance lamp and a turn signal lamp may have a lamp body that accommodates an extension reflector and inner lenses that configure the respective indicator lamps. With this type of headlamp, it is desirable to perform simultaneous main-sub component molding of the extension reflector and the inner lenses.

### BRIEF DESCRIPTION OF THE DRAWINGS

FIG. 1 shows a front view of a headlamp for an automobile that is assembled from an extension reflector and an inner lens that are injection molded according to the present invention.

FIG. 2 shows a cross sectional view along line II-II in FIG. 1 of the headlamp of FIG. 1.

FIG. 3 shows a cross sectional view along line III-III in FIG. 1 of the headlamp of FIG. 1.

FIG. 4 shows a cross sectional view along line IV-IV in FIG. 1 of the headlamp of FIG. 1.

FIG. 5 shows a cross sectional view along line V-V in FIG. 6 of a mold which constitutes a main portion of an injection molding apparatus according to a first embodiment of the invention.

FIG. 6 is a plan view of a simultaneous main-sub component mold used in the mold shown in FIG. 5.

FIG. 7 shows a cross sectional view along line VII-VII in FIG. 8 of a mold which constitutes a main portion of an injection molding apparatus according to a second embodiment of the invention.

FIG. 8 is a plan view of a simultaneous main-sub component mold used in the mold shown in FIG. 7.

FIG. 9 shows a longitudinal section of a mold device which constitutes a main portion of an injection molding apparatus according to a third embodiment of the invention.

FIG. 10 is a plan view of a simultaneous main-sub component mold which constitutes a main portion of an injection molding apparatus according to a fourth embodiment of the invention.

FIG. 11 is a plan view of a simultaneous main-sub component mold which constitutes a main portion of an injection molding apparatus according to a fifth embodiment of the invention.

FIG. 12 is a plan view of a simultaneous main-sub component mold which constitutes a main portion of an injection molding apparatus according to a sixth embodiment of the invention.

FIG. 13 is a cross sectional view along a line XIII-XIII in FIG. 14 of a mold which constitutes a main portion of a conventional injection molding apparatus.

FIG. 14 is a plan view of a simultaneous main-sub component mold of the apparatus of FIG. 13.

### DETAILED DESCRIPTION OF EMBODIMENTS

Hereinafter, the present invention will be described with reference to several non-limiting embodiments.

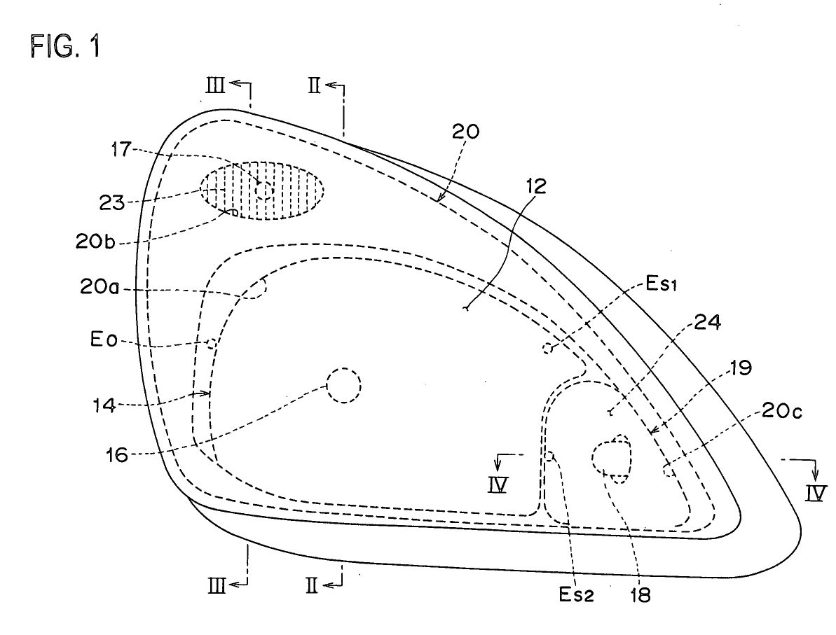

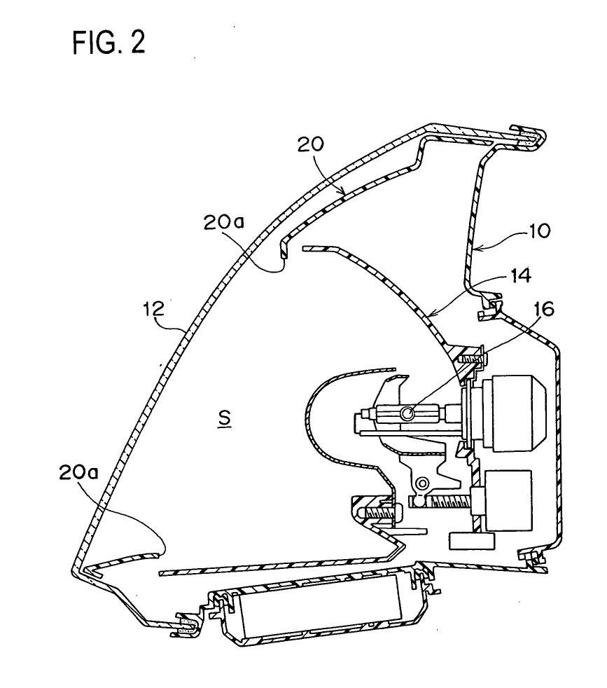

FIG. 1 shows the front view of an automobile headlamp with integrated clearance lamp and turn signal lamp. In this headlamp, a lamp chamber S (FIG. 2) is defined by assembly of a transparent front cover 12 with an open front portion of a container-like lamp body 10. In the lamp chamber S, a reflector 14 is integrated with a light source constituted, in one embodiment, by a discharge bulb 16, which is supported in tiltable fashion in the lamp chamber S by an aiming mechanism (one aiming support E0 and two aiming screws ES1, ES2), to enable tilt adjustment (aiming) of an optical axis of the head lamp up, down, left, and/or right.

An extension reflector 20 made of polycarbonate (PC) resin is provided inside the front open portion of the lamp body 10 so as to extend around a periphery of the reflector 14. The extension reflector 20 has an open portion 20a that matches the outer periphery of the reflector 14 so as not to block reflected light distribution from the reflector 14 which is disposed rearwardly of the open portion 20a. Respective front sides of the extension reflector 20 and the reflector 14 are coated by aluminum evaporation so that the entire inside of the lamp chamber S appears to be reflective, and so that the headlamp is attractive when unlit.

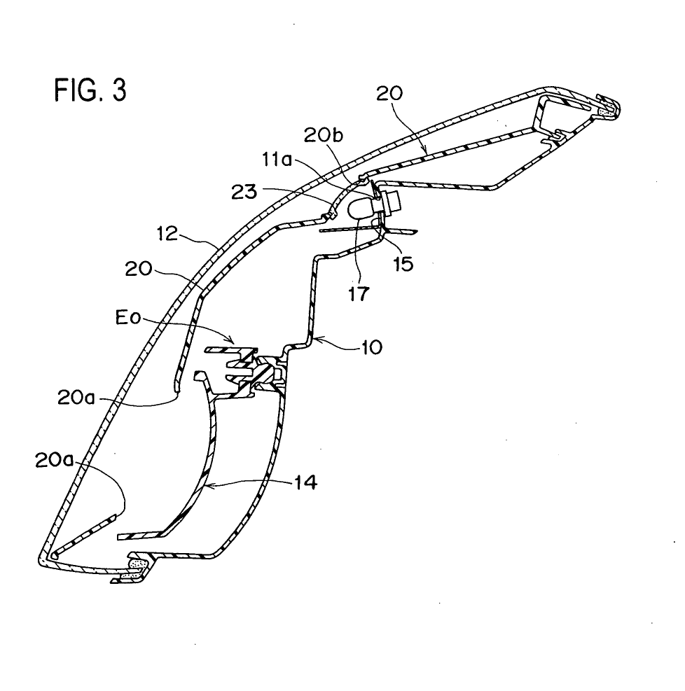

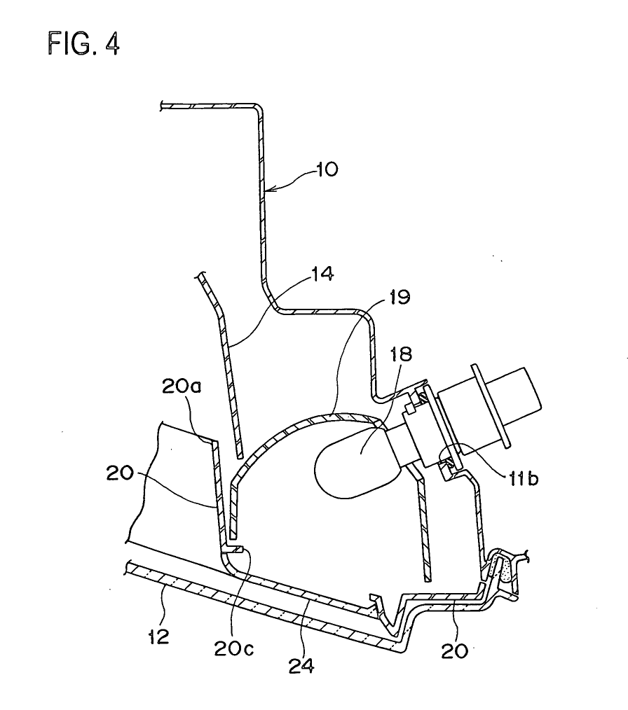

Referring to FIG. 1, which shows the front view of the headlamp, and also to FIG. 4, bulbs 17, 18 are inserted into respective bulb insertion holes 11a, 11b that are provided in a left top corner (an upper corner that extends toward the outside of a vehicle) and a right bottom corner (a lower corner that extends toward the center of the vehicle) of the lamp body 10. In this embodiment, bulb 18 is amber. Transparent inner lenses 23, 24 made of PC resin are welded integrally to open portions 20b, 20c of the extension reflector 20 corresponding to the respective bulbs 17, 18. The clearance lamp is formed from a reflector 15 (FIG. 3) provided around the bulb insertion hole 11 on the inner side of the lamp body 10, the white bulb 17, and the inner lens 23. A reflector 19 that faces the open portion 20c is fixed to a rear surface side of the extension reflector 20. The turn signal lamp is formed from the reflector 19, the amber bulb 18, and the inner lens 24.

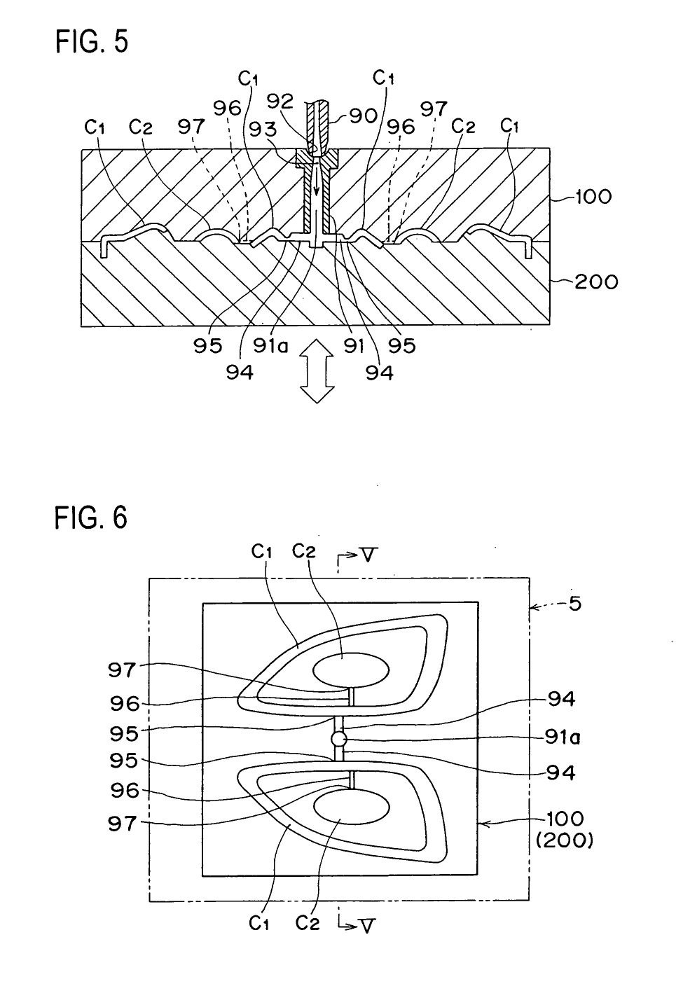

The extension reflector 20 and the inner lens 23, which are resin components of the automobile headlamp which is shown in FIGS. 1 to 4, are injection molded by the molding apparatus shown in FIGS. 5 and 6. It should be noted that the extension reflector 20 shown in FIGS. 5 and 6, which is the resin component that is injection molded by the molding apparatus, is actually an extension reflector base material before surface processing such as aluminum evaporation. However, for the sake of simplicity, the reflector 20 is referred to here as an extension reflector.

The injection molding apparatus is provided with a mold that is configured principally from a fixed mold half 100 that is supplied with resin from an injector nozzle 90, and a movable mold half 200 that can be moved in opposite opening-closing directions (up-down directions in FIG. 5) with respect to the fixed mold half 100. It should be noted that the movable mold half 200 can be actuated by a mold drive mechanism constituted by a hydraulic pressure cylinder mechanism (not shown).

A pair of first cavities C1, C1, which are used for molding the extension reflectors 20, 20, which are resin components of the left and right headlamps, are positioned symmetrically along a line, and are formed by the fixed mold half 100 and the movable mold half 200. Second cavities C2, C2, which are used for molding the inner lenses 23, 23 for the clearance lamp, are similarly formed and are disposed symmetrically along a line, inside respective ones of the first cavities C1, C1 that surround the cavities C2, C2. It should be noted that, since the open portions 20b, 20c for attaching the inner lenses 23, 24 are provided in the extension reflector 20, portions that correspond to the open portions 20b, 20c for attaching the inner lenses are provided in the actual first cavities C1, C1 . However, for the sake of simplicity of description, the portions that correspond to these open portions have been omitted from the drawings.

The insides of the first cavities C1 are connected respectively to the insides of the second cavities C2 via runners 96 and side gates 97. The fixed mold half 100 has a sprue bush 91 with a resin pouring hole 93 that opens to a nozzle engagement portion 92. The resin pouring hole 93 is connected to the first cavities C1 via runners 94 and side gates 95 that extend perpendicularly to a sprue portion 91a from an inside bottom portion of the sprue bush 91.

After closing of the mold halves 100, 200, molten resin (PC resin) is poured from the resin pouring injector nozzle 90 into the resin pouring hole 93 of the fixed mold half 100. The poured molten resin is injected into the first cavities C1 from the side gates 95, via the sprue bush 91 (the sprue portion 91a) and the runners 94, which are resin supply passages provided in the mold halves 100 and 200. When the insides of the first cavities C1 are substantially filled with resin, the resin within the first cavities C1 is injected to the second cavities C2 via the runners 96 and the side gates 97. In this fashion, both the first cavities C1 and the second cavities C2 become filled with resin.

When filling of the first and second cavities C1, C2 is completed, the molded components (the extension reflectors 20 and the inner lenses 23) are removed after a dwell pressure process, a cooling process, and a mold opening process.

As has been described, in one or both of the mold halves 100, 200, the small second cavities C2 for molding the inner lenses 23 are provided inside the first cavities C1 which mold the extension reflectors 20 and which surround the second cavities C2. As a result, the inventive mold is more compact than the conventional simultaneous main-sub component molding mold 5, in which the second cavities are provided outside the first cavities. The inventive mold is the same size as the mold which independently molds extension reflectors, in which only first cavities are provided, without second cavities.

As a result of the foregoing construction,.the hydraulic mechanism and the injector that are utilized to drive the inventive mold device may have smaller driving force and capacity than is necessary for the conventional simultaneous main-sub component mold.

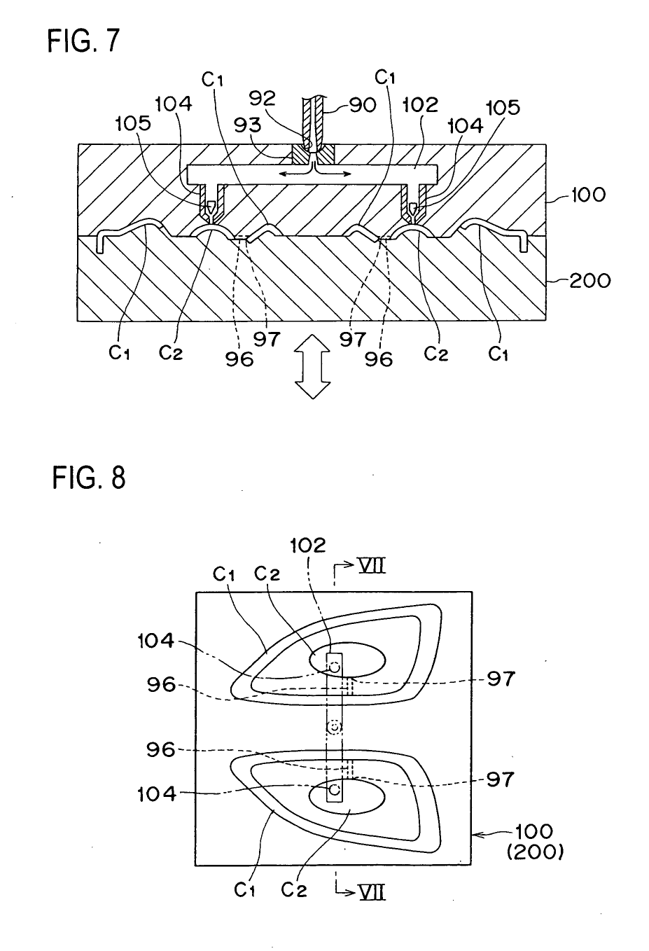

FIGS. 7 and 8 show an injection mold device according to a second embodiment of the invention. In the case of the first embodiment as described above, after resin has filled the first cavities C1, the resin within the first cavities C1 is injected to the second cavities C2 via the runners 96 and the side gates 97. In the second embodiment, after resin has substantially filled the second cavities C2, the resin within the second cavities C2 is injected to the first cavities C1 via the runners 96 and the side gates 97.

In the second embodiment, the mold half 100 includes a hot runner 102 and hot tips 104, which are resin passages to the first cavities C1. Molten resin supplied to the mold half 100 from the injector nozzle 90 is injected to the second cavities C2 via the hot runner 102 and the hot tips 104, and then is injected to the first cavities C1 via the runners 96 and the gates 97.

Other than what has just been described, the second embodiment is the same as the first embodiment in relevant detail, and thus the same reference numerals have been used, and repeated explanation omitted.

It should be noted that, in the first and second embodiments, if the second cavities C2 for molding the inner lenses 24 of the turn signal lamp, rather than the second cavities C2 for molding the inner lenses 23 of the clearance lamp, are formed between the mold halves 100, 200, it is possible to mold the extension reflectors 20 and the inner lenses 24 of the turn signal lamp simultaneously. It also should be noted that reference number 105 denotes a shut off pin.

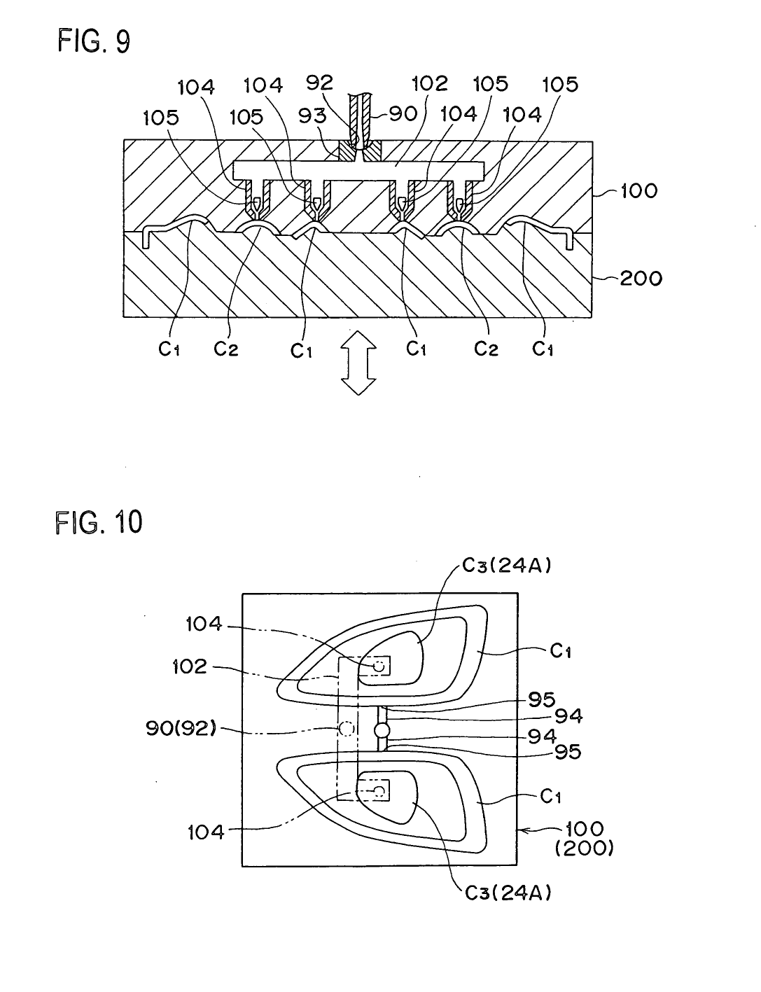

In the third embodiment shown in FIG. 9, the hot runner 102, which is a resin supply passage, is connected to the first cavities C1 and the second cavities C2 via respective hot tips 104, which are branch supply passages. Thus, the injector nozzle 90 injects molten resin into the first cavities C1 and the second cavities C2 respectively via the hot runner 102 and the hot tips 104.

Only one injector is necessary in this embodiment. The configuration of the injection mold device is simple, and at the same time, the resin filling time for the cavities is short. As a result, the injection molding process time is shortened.

In the first to third embodiments, the second cavities C2 for molding the inner lenses 23 of the clearance lamp are formed inside the first cavities C1 for molding the extension reflectors 20, between the fixed mold half 100 and the movable mold half 200. However, in the fourth embodiment, shown in FIG. 10, third cavities C3 for molding the inner lenses 24 of the turn signal lamp are formed inside the first cavities C1 for molding the extension reflectors 20.

In addition, in the first and second embodiments, after either the first or second cavities are substantially filled with resin, resin is injected to the other cavities via the runners 96 and the side gates 97. However, in the fourth embodiment, respective resin passages that supply resin to the first and third cavities (the sprue bush 91 (the sprue portion 91a) and the runner 94 which are resin passages to the first cavities C1, and the hot runner 102 and the hot tips 104 which are resin passages to the third cavities C3) are provided separately in the mold halves 100, 200. This configuration makes it possible to inject different resins into the first and third cavities C1, C3.

Thus, in a manner similar to the first embodiment, molten resin (a transparent PC resin) supplied from a first injector is injected from the gates 95 to the first cavities C1 via the sprue bush 91 (the sprue portion 91a) and the runner 94 (see FIG. 5). On the other hand, in a manner similar to the second embodiment, molten resin supplied from a second injector is injected to the third cavities C3 from the hot tips 104 via the hot runner 102 (see FIG. 7). The molten resin supplied from the second injector is an amber colored PC resin, and thus amber colored molded components are molded in the third cavity C3.

The extension reflector 20 and an amber colored inner lens 24A for the turn signal lamp may be molded in this embodiment. As a result, the embodiment can be used for amber color molding, for the functional color of the turn signal lamp of the headlamp, and can be set for specifications that combine an amber colored inner lens 24A with a white bulb, instead of the transparent inner lens 24 and the amber bulb 18.

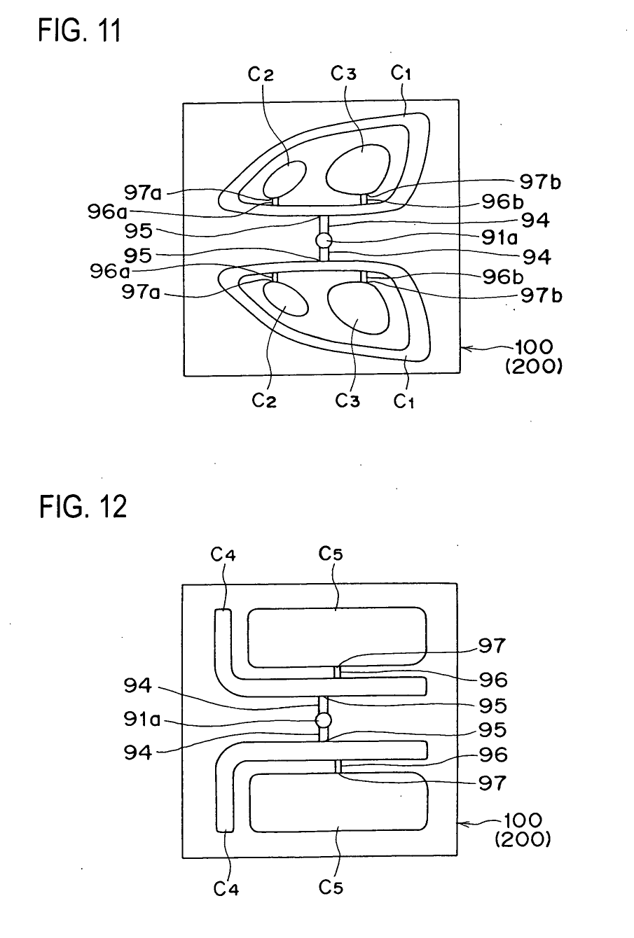

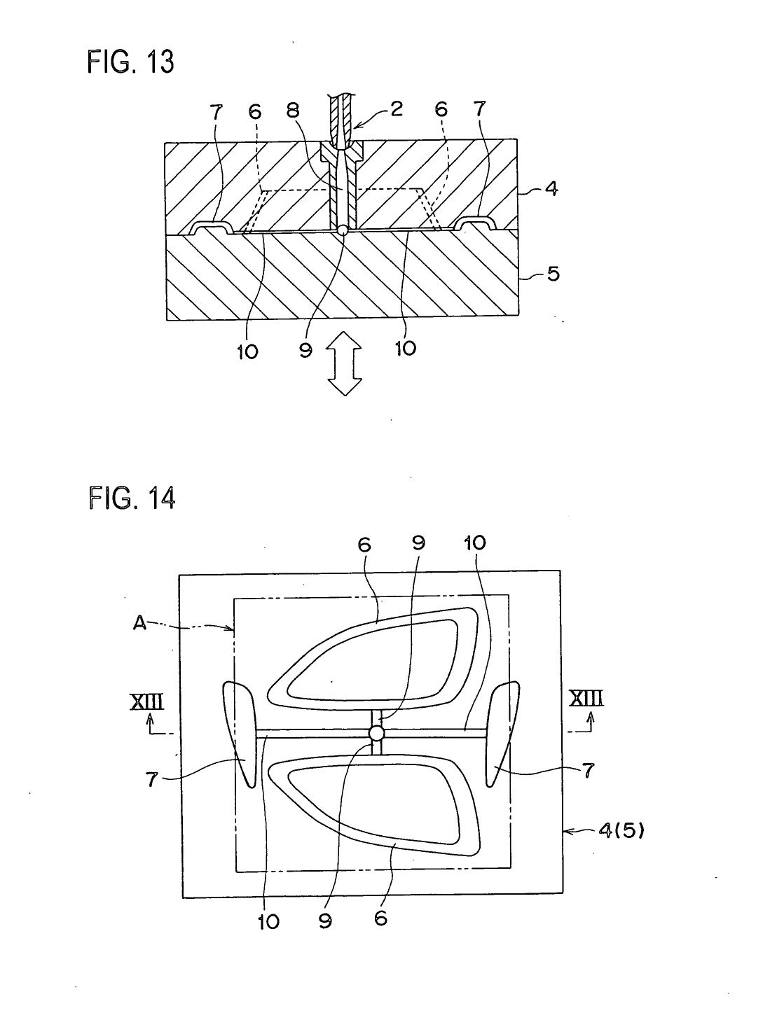

In the various embodiments described above, the second cavities C2 for molding the inner lenses 23 for the clearance lamp (or the third cavities C3 for molding the inner lenses 24, 24A for the turn signal lamp) are formed inside the first cavities C1 between the mold halves 100 and 200, so that the extension reflectors 20 and the inner lenses 23 for the clearance lamp (or the inner lenses 24 for the turn signal lamp) can be molded simultaneously. However, in the fifth embodiment, shown in FIG. 11, the second cavities C2 for molding the inner lenses 23 for the clearance lamp, and the third cavities C3 for molding the inner lenses 24 for the turn signal lamp, are formed inside the first cavities C1 between the mold halves 100, 200. Accordingly, the fifth embodiment enables simultaneous molding of three different types of resin components, namely, the extension reflectors 20, the inner lenses 23 for the clearance lamp, and the inner lenses 24 for the turn signal lamp.

In the fifth embodiment, the first cavities C1 and the second cavities C2 are connected via runners 96a and side gates 97a, which are resin passages, and the first cavities C1 and the third cavities C3 are connected via runners 96b and side gates 96b, which also are resin passages. The fixed mold half 100 is provided with the sprue bush 91 that has the resin pouring hole 93 that opens to the nozzle engagement portion 92. The resin pouring hole 93 is connected to the first cavities C1 via the runners 94 and the side gates 95 that extend orthogonally from the sprue bush 91 (the sprue portion 91a) (see FIG. 5). Molten resin (PC resin), which is supplied from the injector nozzle 90 to the mold half 100, is injected to the first cavities C1 from the side gates 95 via the resin supply passages formed in the mold halves 100, 200, and then is injected into the second and third cavities C2, C3 from the side gates 97a, 97b.

The first to fifth embodiments described above have a mold construction that makes possible simultaneous main-sub component molding of the extension reflectors 20 and the inner lenses 23, 24. However, according to a sixth embodiment of the invention, shown in FIG. 12, it also is possible to perform simultaneous main-sub component molding of extension reflectors and reflectors of turn signal lamps by forming a cavity for molding the reflector 19 of the turn signal lamp inside the cavities for molding the extension reflectors 20 between the mold halves 100, 200, and injecting polybutylene terephthalate (PBT) or polyethylene terephthalate (PET) into both cavities.

The first to fifth embodiments have a simultaneous main-sub component mold construction for the extension reflectors 20 and the inner lenses 23, 24 (24A). In the sixth embodiment, the mold configuration makes possible simultaneous main-sub component molding of an acrylonitrile butadiene styrene (ABS) lamp body for a marker lamp, and an ABS resin rim which is L-shaped when viewed from the front, which is a decorative resin component that hides a gap between the vehicle body and the marker lamp, and which is assembled in an integrated manner at an external periphery of the lamp body for the marker lamp.

Cavities C4 for molding the L-shaped rim are formed to be symmetric along a line that is close to a central portion of the mold half 100 (200). Cavities C5 for molding the lamp body of the marker lamp are formed to be symmetric along a line as well, and are formed inside a curved corner portion of the cavities C4.

The cavities C4 and C5 are connected by side gates 97 which are resin passages; in addition, resin supply passages that are the same as in the first embodiment resin supply passages (the sprue bush 91 (the sprue portion 91a), the runners 94, and the side gates 95) (see FIG. 5) are provided in the mold halves 100, 200. Molten resin (ABS resin) is injected into the cavities C4 and C5.

It should be noted that, in the various embodiments described above, the circular extension reflector and the L-shaped rim for the marker lamp have been suggested as the main-component that is injection molded during simultaneous main-sub component molding, and the inner lens (the reflector of the turn signal lamp) and the lamp body for the marker lamp have been suggested as the sub-component. However, the main-components and sub-components are not limited to these. The main component may be a large resin component having a frame-like shape, such as a circular shape, a U-shape, or an L-shape. The sub-component may be a small resin component that can be positioned without interference inside the main component.

As will be apparent from the above explanation, according to the inventive molding method and apparatus, it is possible to execute main-sub component simultaneous molding without increasing mold size; accordingly, mold construction cost is reduced. Further, with the mold being smaller than the conventional mold, less energy is necessary to open and close the mold, and it is possible to make the overall injection molding apparatus, including the resin supply device, smaller. As a result, it is possible to lower the manufacturing costs of the resin manufactured components.

It is possible to inject resin into both the first and second cavities by injecting resin into only one of the cavities. As a result, only one injector is necessary, and the construction of the molding apparatus is simple. Alternatively, different molten resins may be supplied from respective injectors; accordingly, it is possible to mold a plurality of resin components having different colors or materials simultaneously using a single mold device.

Branch supply passages may facilitate supply of molten resin in the single resin supply passage, to enable injection into the first and second cavities via branch supply passages. Accordingly, simultaneous injection of a resin into both the first and second cavities is possible. Only one injector is necessary, and the configuration of the injection molding apparatus is simple; in addition, the resin filling time for the cavities is short, and thus the injection molding process time is shortened.

With the invention, it is possible to mold the extension reflector and another resin component of the headlamp at low cost, thereby making it possible to supply lower-cost headlamps.

It should be apparent to those of working skill in the art that various changes in form and detail within the spirit of the invention as shown and described above are possible. It is intended that such changes be included within the spirit and scope of the claims appended hereto.

What is claimed is:

1. Apparatus for molding components of a vehicular headlamp, the apparatus comprising:
a mold, the mold comprising:
a first mold cavity for molding a first resin component of the vehicular headlamp, the first resin component having a shape selected from the group consisting of a substantially circular shape, a substantially U-shape, and a substantially L-shape; and
a second mold cavity for molding a second resin component of the vehicular headlamp, the second resin component being sufficiently smaller than said main component that said second mold cavity fits within said first mold cavity in said mold and enables molding of said first resin component and said second resin component without having those components interfere with each other, such that a size of the mold for molding both the first resin component and the second resin component is substantially the same size as a size of the mold for molding only the first resin component;
the apparatus further comprising an injection nozzle for injecting resin into said first and second mold cavities.

2. The apparatus according to claim 1, wherein the mold further comprises a first resin passage for connecting the first and second mold cavities, and a resin supply passage receiving said resin from said injection nozzle, and supplying said resin to one of the first and second mold cavities.

3. The apparatus according to claim 1, wherein the mold further comprises a further injection nozzle, and at least first and second resin supply passages receiving said resin from said injection nozzles and supplying said resin to the first and second mold cavities.

4. The apparatus according to claim 1, further comprising a resin supply passage receiving resin from said injection nozzle and having a branch connected to said first and second mold cavities to inject resin into the first and second mold cavities.

5. The apparatus according to claim 1, wherein said first resin component is an extension reflector for a headlamp, and the second resin component is another portion of the headlamp, but is smaller than an open portion of the extension reflector.

6. A mold device for molding components of a vehicular headlamp, the mold device comprising:
a first mold cavity for molding a first resin component of the vehicular headlamp, the first resin component having a shape selected from the group consisting of a substantially circular shape, a substantially U-shape, and a substantially L-shape; and
a second mold cavity for molding a second resin component of the vehicular headlamp, the second resin component being sufficiently smaller than said first resin component that said second mold cavity fits within said first mold cavity in said mold and enables molding of said first resin component and said second resin component without having those components interfere with each other, such that a size of the mold for molding both the first resin component and the second resin component is substantially the same size as a size of the mold for molding only the first resin component.

7. The mold device according to claim 6, further comprising a first resin passage for connecting the first and second mold cavities, and a resin supply passage supplying resin to one of the first and second mold cavities.

8. The mold device according to claim 6, further comprising at least first and second resin supply passages supplying resin respectively to the first and second mold cavities.

9. The mold device according to claim 6, further comprising a resin supply passage having a branch connected to said first and second mold cavities for supplying resin into the first and second mold cavities.

10. The mold device according to claim 1, wherein said first resin component is an extension reflector for a headlamp, and the second resin component is another portion of the headlamp, but is smaller than an open portion of the extension reflector.

11. A method of injection molding components of a vehicular headlamp, the method comprising:
injecting resin into a first mold cavity for molding a first resin component of the vehicular headlamp, the first resin component having a shape selected from the group consisting of a substantially circular shape, a substantially U-shape, and a substantially L-shape; and
injecting resin into a second mold cavity for molding a second resin component of the vehicular headlamp, the second resin component being sufficiently smaller than said first resin component that said second mold cavity fits within said first mold cavity in said mold and enables molding of said first resin component and said second resin component without having those components interfere with each other, such that a size of the mold for molding both the first resin component and the second resin component is substantially the same size as a size of the mold for molding only the first resin component.

12. The method according to claim 11, wherein the first and second mold cavities are connected by a first resin passage; and
wherein the method further comprises injecting resin into said first mold cavity; and
wherein resin passes from said first mold cavity to said second mold cavity.

13. The method according to claim 11, wherein the first and second mold cavities are connected by a first resin passage; and
wherein the method further comprises injecting resin into said second mold cavity; and
wherein resin passes from said second mold cavity to said first mold cavity.

14. The method according to claim 11, wherein the first and second mold cavities have respective resin supply passages;
the method further comprising injecting a first resin into said first mold cavity via said first resin supply passage, and injecting a second resin into said second mold cavity via said second resin supply passage.

15. The method according to claim 14, wherein said first resin is the same as said second resin.

16. The method according to claim 14, wherein said first resin is different from said second resin.

17. The method according to claim 11, wherein said first and second mold cavities are connected by a resin supply passage having a branch substantially at a midpoint thereof; and
wherein said method further comprises injecting resin into said first and second mold cavities via said resin supply passage.

18. The method according to claim 11, wherein said first resin component is an extension reflector for a headlamp, and the second resin component is another portion of the headlamp, but is smaller than an open portion of the extension reflector.
